(19) United States
(12) Patent Application Publication
(10) Pub. No.: US 2020/0206701 A1
(43) Pub. Date: Jul. 2, 2020

(54) STATIC MIXERS WITH INTERCHANGEABLE MIXING ELEMENTS

(71) Applicant: Hamilton Sundstrand Corporation, Charlotte, NC (US)

(72) Inventors: Nathan F. Champion, Enfield, CT (US); Mohammed Hasan, New Britain, CT (US)

(21) Appl. No.: 16/237,079

(22) Filed: Dec. 31, 2018

(51) Int. Cl. B01F 5/06

(52) U.S. Cl. CPC B01F 5/0602; B01F 2005/0637

(57) ABSTRACT

An interchangeable mixing element for a static mixer includes a mount portion arranged for fixation to an exterior of a manifold body and an insert portion extending from the mount portion. The mount portion is arranged for support within a mixing element seat of the manifold body by the mount portion. The insert portion defines a mixing chamber having an inlet, an outlet opposite the inlet, and a tortuous path fluidly coupling the outlet to the inlet to intermix a first fluid flow and a second fluid received at the inlet of the mixing element into an intermixed fluid flow issued from the outlet of the mixing element. Static mixers and methods of making static mixers are also described.

### STATEMENT OF FEDERAL SUPPORT

This invention was made with Government support under Contract NNJ06TA25C awarded by National Aeronautics and Space Administration (NASA). The Government has certain rights in the invention.

### BACKGROUND

The subject matter disclosed herein generally relates to the fluid systems, and more particularly static mixers for fluid systems such as employed in thermal management systems for space vehicles.

Fluid systems, such as thermal management systems on vehicles, common provide coolant flows to various devices carried by the vehicle. Because the cooling requirements of one or more of the devices can vary over time and with respect to the other devices, coolant flows returning to the fluid system from the various devices can differ in temperature. For that reason fluid mixers are commonly employed to mix the returning coolant flows prior to the fluid system returning the coolant to the devices. The fluid mixer generally includes a mixing structure supported in the fluid flow to induce turbulence in a fluid flow traversing the mixing structure. The turbulence induced in the flow by the mixing structure reduces temperature variation within the fluid flow. Typically, additional homogenization of the fluid flow occurs in the fluid channel downstream of the mixing structure.

Such fluid mixers have generally be acceptable for their intended purpose. However, a need remains for improved mixers for fluid systems. The present disclosure provides a solution to this need.

### BRIEF SUMMARY

According to one embodiment, an interchangeable mixing element for a static mixer is provided. The interchangeable mixing element for a static mixer includes a mount portion arranged for fixation to an exterior of a manifold body and an insert portion extending from the mount portion. The mount portion is arranged for support within a mixing element seat of the manifold body by the mount portion. The insert portion defines a mixing chamber having an inlet, an outlet opposite the inlet, and a tortuous path fluidly coupling the outlet to the inlet to intermix a first fluid flow and a second fluid received at the inlet of the mixing element into an intermixed fluid flow issued from the outlet of the mixing element. Static mixers and methods of making static mixers are also described.

In addition to one or more of the features described above, or as an alternative, further embodiments may include wherein the mount portion has a fastener pattern to fix the mixing element to a manifold body of the static mixer.

In addition to one or more of the features described above, or as an alternative, further embodiments may include a seal member arranged between the mount portion and the insert portion, the seal member extending about the insert portion of the mixing element.

In addition to one or more of the features described above, or as an alternative, further embodiments may include wherein the insert portion comprises a singular baffle extending from the mount portion and positioned within the mixing chamber; a first projection extending from the mount portion and spaced apart from the baffle; and a second projection extending from the mount portion and connected to the baffle, the first and second projections defining between one another an inlet and an outlet, the baffle arranged between the inlet and the outlet to oppose fluid flow between the inlet and the outlet.

In addition to one or more of the features described above, or as an alternative, further embodiments may include wherein the insert portion comprises an annulus arranged on the insert portion and opposite the mount portion.

In addition to one or more of the features described above, or as an alternative, further embodiments may include wherein the insert portion further comprises a footer coupling the baffle to the first projection.

In addition to one or more of the features described above, or as an alternative, further embodiments may include wherein the baffle is oriented obliquely relative to at least one of the inlet and the outlet of the mixing element.

In addition to one or more of the features described above, or as an alternative, further embodiments may include wherein the insert portion comprises a plurality of baffles extending from the mount portion and positioned within the mixing chamber; a first projection extending from the mount portion and connected to the at least one of the plurality of baffles; and a second projection extending from the mount portion and connected to at least one of the plurality of baffles.

In addition to one or more of the features described above, or as an alternative, further embodiments may include wherein each of the plurality of has a flow aperture extending therethrough, the flow apertures arranged along the tortuous path extending between the inlet and the outlet.

In addition to one or more of the features described above, or as an alternative, further embodiments may include wherein at least one of the plurality of baffles has a corrugated profile.

In addition to one or more of the features described above, or as an alternative, further embodiments may include wherein the insert portion of the mixing element is cylindrical in shape.

According to another embodiment a static mixer is provided. The static mixer includes a manifold body defining a mixing element seat, a first inlet channel, a second inlet channel and an outlet channel, and a mixing element as described above. The mount portion of the mixing element is fixed to the exterior of the manifold body, the insert portion of the mixing element is supported within the mixing element seat by the mount portion, and wherein the mixing chamber of the insert portion fluidly connects the first inlet channel and the second inlet channel with the outlet channel.

In addition to one or more of the features described above, or as an alternative, further embodiments may include wherein the mount portion of the mixing element has a fastener pattern to fix the mixing element to a manifold body of the static mixer, and further comprising a seal member arranged between the mount portion and the insert portion, the seal member extending about the insert portion of the mixing element.

In addition to one or more of the features described above, or as an alternative, further embodiments may include at least one fastener fixing the mixing element to the manifold body.

In addition to one or more of the features described above, or as an alternative, further embodiments may include wherein the insert portion of the mixing element comprises a singular baffle extending from the mount portion and positioned within the mixing chamber, a first projection extending from the mount portion and spaced apart from the baffle, and a second projection extending from the mount portion and connected to the baffle, the first and second projections defining between one another an inlet and an outlet, the baffle arranged between the inlet and the outlet to oppose fluid flow between the inlet and the outlet.

In addition to one or more of the features described above, or as an alternative, further embodiments may include wherein the insert portion comprises an annulus arranged on the insert portion and opposite the mount portion, wherein the insert portion further comprises a footer coupling the baffle to the first projection, and wherein the baffle is oriented obliquely relative to at least one of the inlet and the outlet of the mixing element.

In addition to one or more of the features described above, or as an alternative, further embodiments may include wherein the insert portion comprises a plurality of baffles extending from the mount portion and positioned within the mixing chamber; a first projection extending from the mount portion and connected to the at least one of the plurality of baffles; and a second projection extending from the mount portion and connected to at least one of the plurality of baffles.

In addition to one or more of the features described above, or as an alternative, further embodiments may include wherein each of the plurality of has a flow aperture extending therethrough, the flow apertures arranged along the tortuous path extending between the inlet and the outlet, and wherein at least one of the plurality of baffles has a corrugated profile.

According to yet another embodiment a method of making a static mixer is provided. The method includes, at a manifold body defining a mixing element seat, a first inlet channel, a second inlet channel, and an outlet channel, supporting an insert portion of a mixing element within the mixing element seat of the manifold body by a mount portion of the mixing element, the insert portion extending from a mount portion. The mount portion is fixed to the exterior of the manifold body. The first inlet channel and the second inlet channel are fluidly coupled to the outlet channel with a mixing chamber defined within the mixing element, the mixing chamber having an inlet, an outlet opposite the inlet, and a tortuous path fluidly coupling the outlet to the port to intermix a first fluid flow and a second fluid received at the inlet of the mixing element into an intermixed fluid flow issued from the outlet of the mixing element.

In addition to one or more of the features described above, or as an alternative, further embodiments may include wherein the mixing element is a first mixing element with an insert portion defining a first mixing chamber, the method further comprising interchanging the first mixing element with a second mixing element, the second mixing element having an insert portion with a second mixing chamber.

Technical effects of embodiments of the present disclosure include reduction of the length of the fluid channel downstream of the static mixer otherwise required to obtain uniform temperature within the fluid flow. In certain embodiments the technical effects also include the capability to alter the geometry of the mixing chamber of the static mixer without altering the geometry of the manifold housing the mixing chamber.

The foregoing features and elements may be combined in various combinations without exclusivity, unless expressly indicated otherwise. These features and elements as well as the operation thereof will become more apparent in light of the following description and the accompanying drawings. It should be understood, however, that the following description and drawings are intended to be illustrative and explanatory in nature and non-limiting.

### BRIEF DESCRIPTION

The following descriptions should not be considered limiting in any way. With reference to the accompanying drawings, like elements are numbered alike:

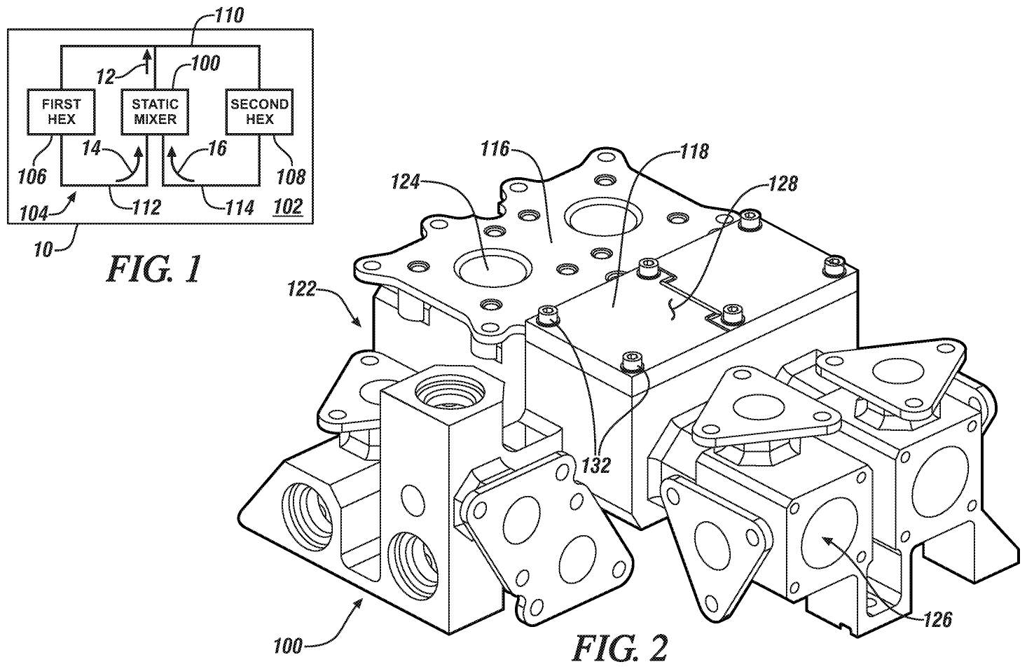

FIG. 1 is block diagram of a thermal management system constructed in accordance with the present disclosure, showing a static mixer connected to first and second heat exchangers by a fluid circuit;

FIG. 2 is a perspective view of the static mixer of FIG. 1, showing a manifold body with a mixing element seated in the manifold body;

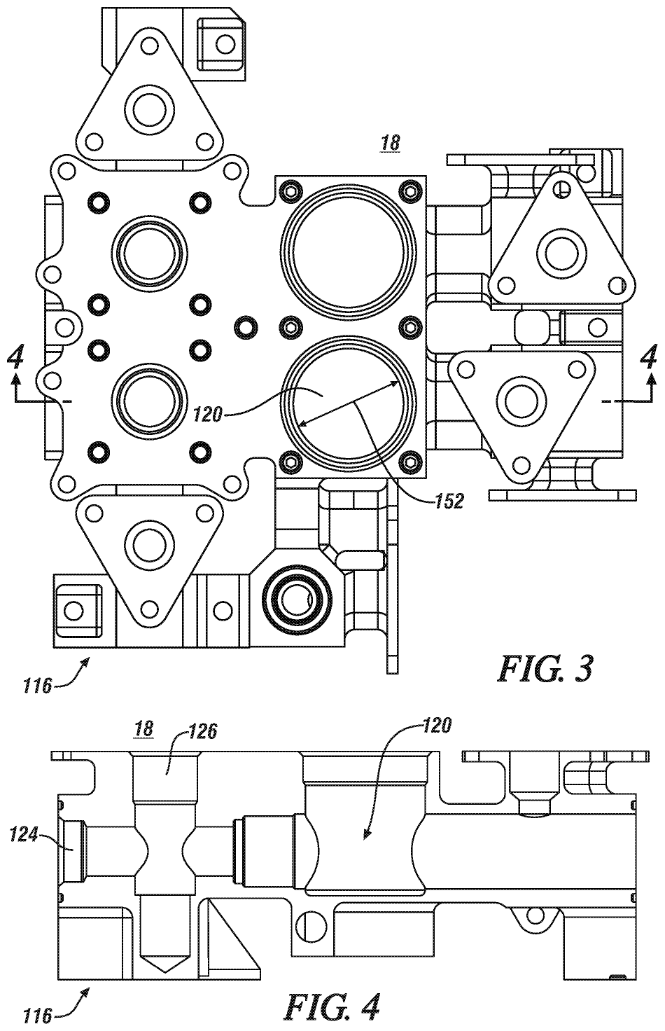

FIGS. 3 and 4 are plan and cross-sectional views of the manifold body of the static mixer illustrated in FIG. 1, showing a mixing element seat defined within the interior of the manifold body, respectively;

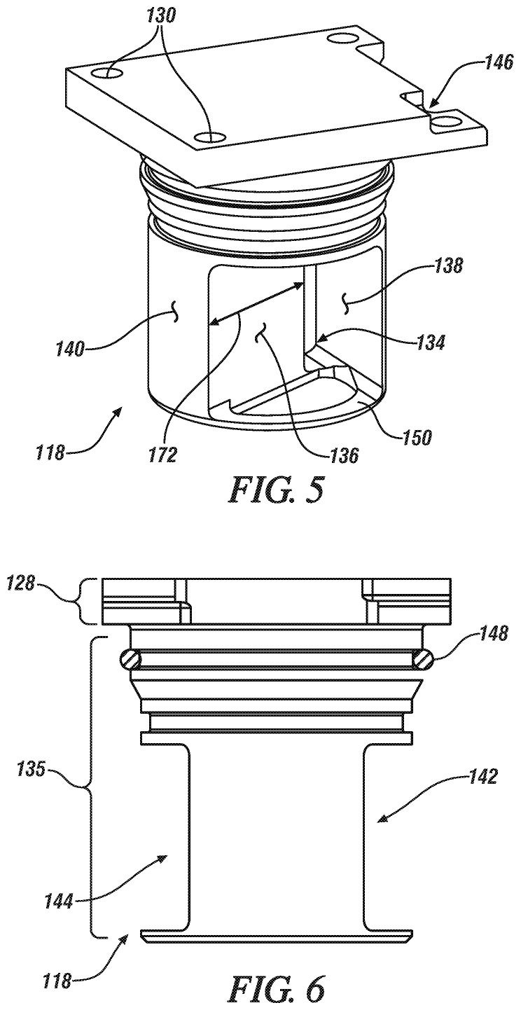

FIGS. 5-8 are perspective, side and plan views of the mixing element of the static mixer illustrated in FIG. 1, showing a singular baffle and projections of the mixing element for inducing turbulence in fluid traversing the mixing element, respectively;

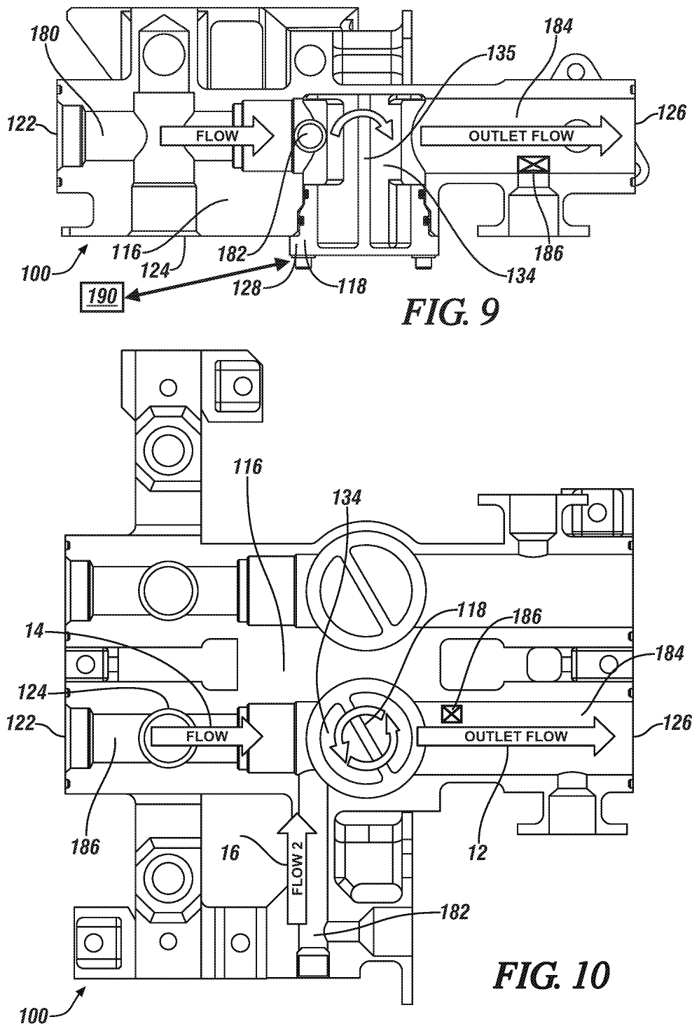

FIGS. 9 and 10 are cross-sectional views of the static mixer illustrated in FIG. 1, showing first and second return fluid flows intermixing within the mixing element and issuing from the mixing element as supply flow;

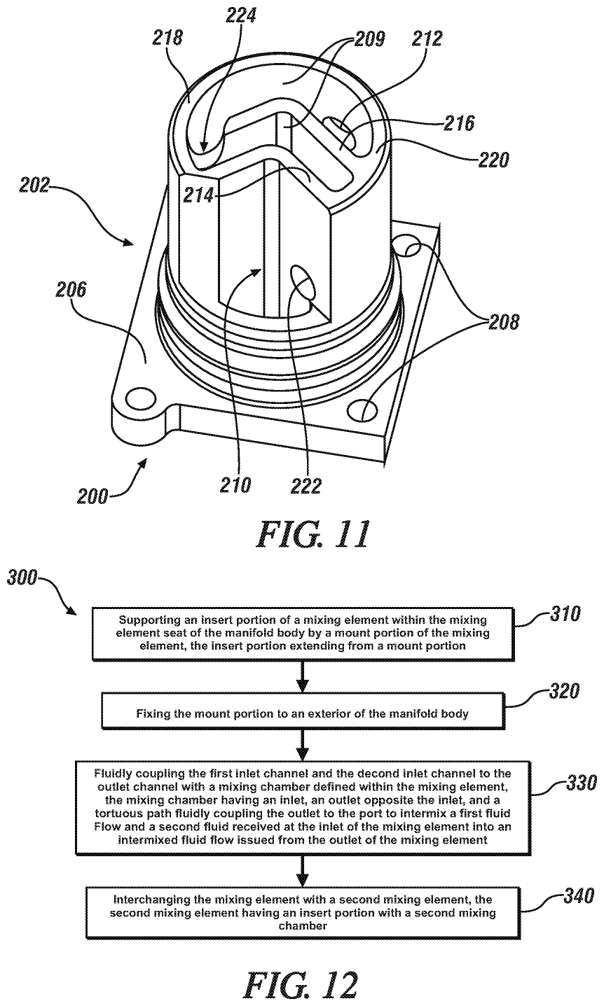

FIG. 11 is a perspective view of another mixing element interchangeable with the mixing element of FIG. 5, showing an insert portion having a mixing chamber with a plurality of baffles; and

FIG. 12 is a process flow diagram of a method of making a static mixer, shown steps of the method.

### DETAILED DESCRIPTION

Reference will now be made to the drawings wherein like reference numerals identify similar structural features or aspects of the subject disclosure. For purposes of explanation and illustration, and not limitation, a partial view of an exemplary embodiment of a static mixer in accordance with the disclosure is shown in FIG. 1 and is designated generally by reference character 100. Other embodiments of static mixers, mixing elements, and thermal management systems having static mixers with such mixing elements in accordance with the present disclosure, or aspects thereof, are provided in FIGS. 2-12, as will be described. The systems and methods described herein can be used for thermal management systems, such as in thermal management systems for space vehicles, though the present disclosure is not limited space vehicles or to thermal management systems in general.

Referring to FIG. 1, a thermal management system 102 is shown. The thermal management system 102 is carried by a vehicle 10, e.g., a space vehicle such as an artificial satellite, and includes a coolant circuit 104 with a first heat exchanger 106, a second heat exchanger 108 and the static mixer 100. A supply conduit 110 connects the static mixer 100 to the first heat exchanger 106 and the second heat exchanger 108 to provide a supply coolant flow 12 to the first heat exchanger 106 and the second heat exchanger 108. The first heat exchanger 106 and the second heat exchanger 108 exchange heat with the supply coolant flow 12 and return the coolant as a first return coolant flow 14 and a second coolant flow 16, which return to the static mixer 100 via a first return conduit 112 and a second return conduit 114, and wherein the first return coolant flow 14 and the second coolant flow 16 are intermixed prior to introduction to the supply conduit 110.

With reference to FIG. 2, the static mixer 100 is shown. The static mixer 100 includes a manifold body 116 and a mixing element 118. The manifold body 116 defines within its interior a mixing element seat 120 (shown in FIG. 3) and has a first inlet port 122, a second inlet port 124, and an outlet port 126. The first inlet port 122 is arranged to fluidly couple to the first return conduit 112 (shown in FIG. 1) to the mixing element seat 120. The second inlet port 124 is arranged to fluidly couple the second return conduit 114 (shown in FIG. 1) to the mixing element seat 120. The outlet port 126 is arranged to fluidly couple the mixing element seat 120 to the supply conduit 110 (shown in FIG. 1).

The mixing element 118 is seated in the mixing element seat 120 (shown in FIG. 3) and is fastened to the manifold body 116. In this respect the mixing element 118 has a mount portion 128 (shown in FIG. 6) with a fastener pattern 130 (shown in FIG. 5). The fastener pattern 130 is arranged to receive therein a plurality of fasteners 132, which are threadably seated in the manifold body 116 and which fix the mixing element 118 to the manifold body 116. It is contemplated that the mixing element 118 be fixed to manifold by 118 such that a mixing chamber 134 (shown in FIG. 5) defined by an insert portion 135 (shown in FIG. 6) of the mixing element fluidly couples the first inlet port 122 and the second inlet port 124 of the manifold body 116 to the outlet port 126 of the manifold body 116.

It is contemplated that the mixing element 118 be interchangeable one or more mixing element having a corresponding mount portion 128. In this respect the mixing element 118 is interchangeable with mixing elements defining mixing chambers of various geometries, and associated mixing efficiencies, which can be interchanged with one another as an assembly forming static mixer 100. As will be appreciated by those of skill in the art in view of the present disclosure, interchangeability enables the mixing performance of the static mixer 100 to be adjusted by replacement of the mixing element 118, limiting (or eliminating entirely) the need to machine or otherwise rework the manifold body 116. This simplifies tuning the performance of the thermal management system 102, such as during acceptance testing of the thermal management system 102 (shown in FIG. 1) by way of non-limiting example.

With reference to FIGS. 3 and 4, the manifold body 116 is shown. The manifold body 116 defines within its interior the mixing element seat 120. The mixing element seat 120 is open to the external environment 18 for receiving the mixing element 118 (shown in FIG. 2) and is cylindrical in shape. As will be appreciated by those of skill in the art in view of the present disclosure, the cylindrical shape of the mixing element seat 120 allows two or more input channels and/or two or more output channels to fluidly connect with the mixing chamber 134 (shown in FIG. 5) defined by the mixing element 118. As will also be appreciated by those of skill in the art in view of the present disclosure, the cylindrical shape of the mixing element seat 120 facilitates sealing the mixing element 118 against the manifold body 116 within the mixing element seat 120, thereby providing interchangeability of the mixing element 118 with other mixing elements.

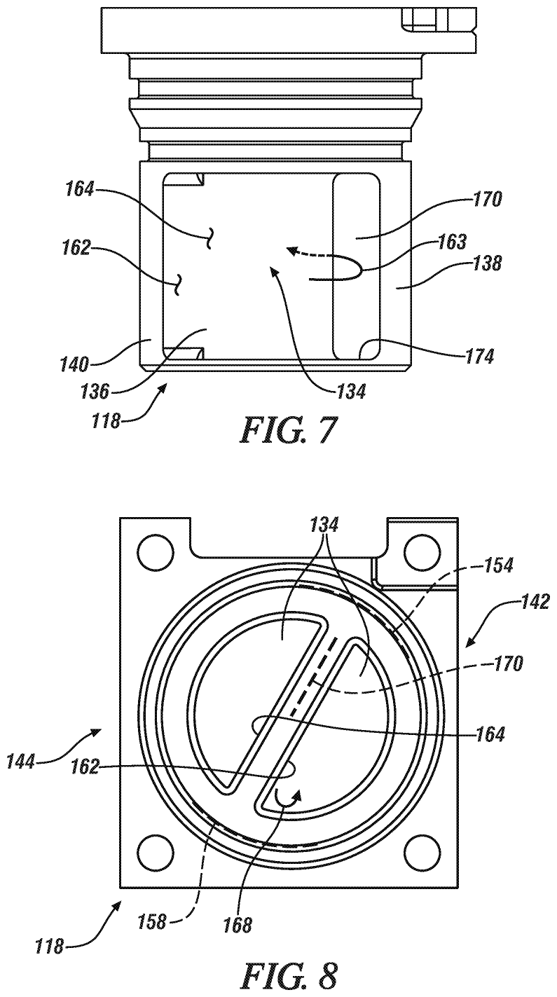

Referring now to FIGS. 5-8, the mixing element 118 is shown. As shown in FIG. 6 the mixing element 118 includes the mount portion 128 and the insert portion 135. As shown in FIGS. 5 and 6, the insert portion 135 extends from the mount portion 128 and has a baffle 136, a first projection 138, and a second projection 140. The baffle 136 extends from the mount portion 128 and is positioned within the mixing chamber 134 defined within the mixing element 118. The first projection 138 extends from the mount portion 128 and is spaced apart from the baffle 136 by an aperture 170 (shown in FIG. 7). The second projection 140 extends from the mount portion 128 and is connected to the baffle 136, the first projection 138 and the second projection 140 defining between one another an inlet 142 (shown in FIG. 6) into the mixing chamber 134 and an outlet 144 (shown in FIG. 6) from the mixing chamber 134. The baffle 136 is arranged between the inlet 142 and the outlet 144 relative to the direction fluid flow through the mixing chamber 134 to oppose fluid flow between the inlet 142 and the outlet 144 of the mixing chamber 134.

As shown in FIG. 5, the fastener pattern 130 includes four (4) apertures for receiving therethrough the fasteners 132 (shown in FIG. 2). In the illustrated embodiment the mount portion 128 also includes a key feature 146. The key feature 146 is arranged to limit the position positional relationships between the mixing element 118 and the manifold body 116 when assembled to a singular relation, thereby error-proofing the assembly of mixing element 118 with the manifold body 116. As shown in FIG. 6, a seal member 148 is arranged about the mixing element 118 between the mount portion 128 and the baffle 136 to sealably fix the mixing element 118 to the manifold body 116.

As also shown in FIG. 5, the mixing element 118 also has an annulus 150. The annulus 150 is arranged on an end of the mixing element 118 opposite the mount portion 128 and dimensionally conforms to a diameter 152 (shown in FIG. 3) of the mixing element seat 120 (shown in FIG. 3). It is contemplated that the annulus 150 bound both the inlet 142 to the mixing chamber 134 and the outlet 144 from the mixing chamber 134. Further, in certain embodiments the annulus 150 may have a height (in the direction toward the mount portion 128) sufficient to create turbulence in fluid flow traversing the mixing chamber 134.

As shown in FIGS. 7 and 8, the baffle 136 has a pressure face 162 and a suction face 164. The suction face 164 is arranged on a side of the baffle 136 opposite the pressure face 158. The pressure face 158 opposes the inlet 142 and defines a flow path 163 traversing the aperture 170 located between the baffle 136 and the first projection 138. It is contemplated that the baffle 136 be angled toward the inlet 142 and away from the outlet 144 to define a recirculation pocket 168 adjacent to a downstream edge of the pressure face 158. As will be appreciated by those of skill in the art in view of the present disclosure, the recirculation pocket 168 promotes intermixing of fluid flows entering the inlet 142 by hiving off portions of the fluid flows for temporal impoundment within the recirculation pocket 168 via swirling action. It is also contemplated that the baffle 136 be a singular baffle, the mixing element 118 having no additional baffle and/or baffle structures positioned within the mixing chamber 134.

It is contemplated that the baffle 136 can have an axial width 172 (shown in FIG. 5) spanning more than half the diameter 152 (shown in FIG. 3) of the mixing element seat 120 (shown in FIG. 3). As will be appreciated by those of skill in the art in view of the present disclosure, this offsets the position of the aperture 170 (shown in FIG. 7) and imparts an off-axis component to the direction of fluid flow through the mixing chamber 134, improving intermixing of fluids introduced into the mixing chamber 134. As will also be appreciated by those of skill in the art in view of the present disclosure, the magnitude of the off-axis component can be changed by selecting a mixing element with shorter or longer length to tune mixing performance of the static mixer 100 (shown in FIG. 1), as suitable for an intended application.

As also shown in FIG. 7, the insert portion 135 has a footer 174. The footer 174 connects the baffle 137 to the annulus 150, and therethrough with first projection 138. This provides additional stiffness to the baffle 136. The height of the footer 174 can also be selected to encourage the recirculation of fluid flows on the upstream and downstream sides of the footer 174, promoting intermixing of fluid flows introduced into the mixing chamber 134.

As shown in FIG. 8, the baffle 136 is oriented obliquely relative to the inlet 142 of the mixing chamber 134. The baffle 136 is also oriented obliquely relative to the outlet 144 of the mixing chamber 134. More specifically, an upstream edge of the baffle 136 adjacent the first projection 138 is oriented toward the inlet 142. This promotes recirculation of fluid introduced into the mixing chamber 134 of the upstream side of the baffle 136, increasing residency time and intermixing of fluid flows introduced into the mixing chamber 134.

The first projection 138 has an axial profile 154 conforming to an arcuate segment of the annulus 150 and the second projection 140 has an axial profile 154 conforming to an arcuate segment 156 of the annulus 150. This provides the insert portion 135 (shown in FIG. 6) with a generally circular shape conforming to the circular shape of mixing element seat 120 (shown in FIG. 3), allowing the first projection 138 and the second projection 140 to direct fluid traversing the mixing element 118 through the mixing chamber 134 by preventing fluid from flowing between the projections and the mixing element seat 120.

With reference to FIGS. 9 and 10, the static mixer 100 is shown in cross-section. As shown in FIG. 10, the manifold body 116 defines within its interior a first inlet channel 180, a second inlets channel 182, and an outlet channel 184. The first inlet channel 180 fluidly couples the first inlet port 122 to the mixing element seat 120, and therethrough to the mixing chamber 134 defined by the insert portion 135 of the mixing element 118. The second inlet channel 182 fluidly couples the second inlet port 124 to the mixing element seat 120, and therethrough to the mixing chamber 134 defined by the insert portion 135 of the mixing element 118. The outlet channel 184 fluidly couples the mixing element seat 120, and therethrough the mixing chamber 134 defined by the insert portion 135 of the mixing element 118, with the outlet port 126.

As shown in FIG. 9, the mixing element 118 is fastened to the manifold body 116. More specifically, the mixing element 118 is fastened to the manifold body 116 such that the insert portion 135 of the mixing element 118 is positioned within the mixing element seat 120 to fluidly couple the first inlet channel 180 and the second inlet channel 182 with the outlet channel 184 with the mixing chamber 134 defined by the mixing element 118. The mount portion 128 of the mixing element 118 is positioned on the exterior of the manifold body 116 to allow interchange of the mixing element 118 with another mixing element 190 for adjusting performance of the static mixer 100.

Advantageously, the above-described arrangement of the insert portion 135 of the mixing element 118 provides uniformity in temperature of flow issuing from the outlet 144 defined by the mixing chamber 134, uniformity meaning a relatively small total indicated range across the flow area at the entrance to the outlet channel 184, sufficient to allow placement of a temperature sensor 186 proximate the mixing element 118. This limits the length of the outlet channel 184, allowing the manifold body 116 to be relatively compact in construction in comparison to manifolds requiring placement of temperatures at locations downstream along the outlet channel due to temperature variation in fluid provided to the outlet channel.

Referring to FIG. 11, a mixing element 200 is shown. The mixing element 200 is similar to the mixing element 118. More particularly, the mixing element 200 is interchangeable with the mixing element 118 (shown in FIG. 2) and includes an insert portion 202 defining a mixing chamber 204 having geometry that is different than that of the mixing element 118. Interchangeability is provided by a mount portion 206, from which the insert portion 202 extends, and which has a fastener pattern 208 defined thereon which is substantially the same as the fastener pattern 130 (shown in FIG. 5) of the mixing element 118. Interchangeability can additionally (or alternatively) be provided by the generally cylindrical shape of the insert portion 202, the location of an inlet 210 and an outlet 212 on the insert portion 202, placement of a seal member about the insert portion 202 at a location between the insert portion 202 and the mount portion 206, etc.

It is contemplated that the mixing performance of the interchangeable mixing element 200 be different than that of the mixing element 118 (shown in FIG. 2). In this respect the illustrated embodiment of the interchangeable mixing element 200 includes a first baffle 214 and a second baffle 216 each extending from the mount portion 206 and positioned within the mixing chamber 204. A first projection 218 extends from the mount portion 206 and is connected to the first baffle 214, and a second projection 220 extends from the mount portion 206 and is connected to the second baffle 216. It is contemplate that the first baffle 214 have a first flow aperture 222, the second baffle 216 have a second flow aperture 224, and that first flow aperture 222 and the second flow aperture 224 be arranged along the tortuous flow path extending between the inlet 210 of the mixing chamber 204 and the outlet 212 of the mixing chamber 224. As will be appreciated by those of skill in the art in view of the present disclosure, the plurality of baffles divide the mixing chamber 204 into a plurality of mixing compartments. This increases dwell time of fluids introduced to the mixing chamber for mixing. As shown in FIG. 11 the first baffle 214 and the second baffle 216 are each corrugated, i.e., have a chevron-like axial profile. As will be appreciated by those of skill in the art in view of the present disclosure, the corrugations of the first baffle 214 and the second baffle 216 can provide a relatively long flow path through the mixing chamber 204 in comparison to mixing chambers not having corrugated baffles.

With reference to FIG. 12, a method 300 of making a static mixer, e.g., the static mixer 100 (shown in FIG. 1), is shown. Method 300 includes supporting an insert portion of a mixing element within a mixing element seat of a manifold body, e.g., the insert portion 135 (shown in FIG. 6) of the mixing element 118 (shown in FIG. 2), as shown with box 310. It is contemplated that the insert portion be supported by the mount portion 128 (shown in FIG. 2), which extends from the mount portion such that the mixing chamber of the mixing element is arranged within the interior of the manifold body, e.g., the manifold body 116 (shown in FIG. 2). In this respect the mount portion is fixed to the exterior of the manifold body, as shown with box 320.

Once inserted the mixing element is registered to inlet channels and an outlet channel in fluid communication with the mixing element seat defined by the manifold body, as shown with box 330. More particularly a first inlet channel, e.g., the first inlet channel 186 (shown in FIG. 10), and a second inlet channel, e.g., the second inlet channel 182 (shown in FIG. 10), is fluid coupled to an outlet channel, e.g., the outlet channel 184 (shown in FIG. 10), as also shown by box 330. This cause the mixing chamber of the insert portion of the mixing element, and more particularly the tortuous flow path extending through the mixing chamber, to fluidly connect the first inlet channel and the second inlet channel to the outlet channel through the inlet and the outlet of the mixing chamber.

It is contemplated that the mixing performance of the static mixer be changed, e.g., tuned, by interchanging a first mixing element for a second mixing element, e.g., the first mixing element 118 for the second mixing element 200, as shown with box 340. As will be appreciated by those of skill in the art in view of the present disclosure, interchangeability limits (or eliminates entirely) the need to replace or rework the manifold body of the static mixer as the mixing element seat can accommodate interchangeable mixing elements having mixing chambers with different geometries, and thereby different mixing performance.

The term “about” is intended to include the degree of error associated with measurement of the particular quantity based upon the equipment available at the time of filing the application. For example, “about” can include a range of ±8% or 5%, or 2% of a given value.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. An interchangeable mixing element for a static mixer, comprising:
a mount portion arranged for fixation to an exterior of a manifold body; and
an insert portion extending from the mount portion and arranged for support within a mixing element seat of the manifold body by the mount portion, the insert portion defining a mixing chamber having:
an inlet;
an outlet opposite the inlet; and
a tortuous path fluidly coupling the outlet to the inlet to intermix a first fluid flow and a second fluid received at the inlet of the mixing element into an intermixed fluid flow issued from the outlet of the mixing element.

2. The mixing element as recited in claim 1, wherein the mount portion has a fastener pattern to fix the mixing element to a manifold body of the static mixer.

3. The mixing element as recited in claim 1, further comprising a seal member arranged between the mount portion and the insert portion, the seal member extending about the insert portion of the mixing element.

4. The mixing element as recited in claim 1, wherein the insert portion comprises:
a singular baffle extending from the mount portion and positioned within the mixing chamber;
a first projection extending from the mount portion and spaced apart from the baffle; and
a second projection extending from the mount portion and connected to the baffle, the first and second projections defining between one another an inlet and an outlet, the baffle arranged between the inlet and the outlet to oppose fluid flow between the inlet and the outlet.

5. The mixing element as recited in claim 4, wherein the insert portion comprises an annulus arranged on the insert portion and opposite the mount portion.

6. The mixing element as recited in claim 4, wherein the insert portion further comprises a footer coupling the baffle to the first projection.

7. The mixing element as recited in claim 4, wherein the baffle is oriented obliquely relative to at least one of the inlet and the outlet of the mixing element.

8. The mixing element as recited in claim 1, wherein the insert portion comprises:
a plurality of baffles extending from the mount portion and positioned within the mixing chamber;
a first projection extending from the mount portion and connected to the at least one of the plurality of baffles; and
a second projection extending from the mount portion and connected to at least one of the plurality of baffles.

9. The mixing element as recited in claim 8, wherein each of the plurality of has a flow aperture extending therethrough, the flow apertures arranged along the tortuous path extending between the inlet and the outlet.

10. The mixing element as recited in claim 8, wherein at least one of the plurality of baffles has a corrugated profile.

11. The mixing element as recited in claim 1, wherein the insert portion of the mixing element is cylindrical in shape.

12. A static mixer, comprising:
a manifold body defining a mixing element seat, a first inlet channel, a second inlet channel and an outlet channel; and
a mixing element as recited in claim 1, wherein the mount portion of the mixing element is fixed to the exterior of the manifold body, wherein the insert portion of the mixing element is supported within the mixing element seat by the mount portion, and
wherein the mixing chamber of the insert portion element fluidly connects the first inlet channel and the second inlet channel with the outlet channel.

13. The static mixer as recited in claim 12, wherein the mount portion of the mixing element has a fastener pattern to fix the mixing element to a manifold body of the static mixer, and further comprising a seal member arranged between the mount portion and the insert portion, the seal member extending about the insert portion of the mixing element.

14. The static mixer as recited in claim 12, further comprising at least one fastener fixing the mixing element to the manifold body.

15. The static mixer as recited in claim 12, wherein the insert portion of the mixing element comprises:
a singular baffle extending from the mount portion and positioned within the mixing chamber;
a first projection extending from the mount portion and spaced apart from the baffle; and
a second projection extending from the mount portion and connected to the baffle, the first and second projections defining between one another an inlet and an outlet, the baffle arranged between the inlet and the outlet to oppose fluid flow between the inlet and the outlet.

16. The static mixer as recited in claim 15, wherein the insert portion comprises an annulus arranged on the insert portion and opposite the mount portion, wherein the insert portion further comprises a footer coupling the baffle to the first projection, and wherein the baffle is oriented obliquely relative to at least one of the inlet and the outlet of the mixing element.

17. The mixing element as recited in claim 12, wherein the insert portion comprises:
a plurality of baffles extending from the mount portion and positioned within the mixing chamber;
a first projection extending from the mount portion and connected to the at least one of the plurality of baffles; and
a second projection extending from the mount portion and connected to at least one of the plurality of baffles.

18. The mixing element as recited in claim 17, wherein each of the plurality of has a flow aperture extending therethrough, the flow apertures arranged along the tortuous path extending between the inlet and the outlet, and wherein at least one of the plurality of baffles has a corrugated profile.

19. A method of making a static mixer, comprising:
at a manifold body defining a mixing element seat, a first inlet channel, a second inlet channel, and an outlet channel,
supporting an insert portion of a mixing element within the mixing element seat of the manifold body by a mount portion of the mixing element, the insert portion extending from a mount portion;
fixing the mount portion to an exterior of the manifold body;
fluidly coupling the first inlet channel and the second inlet channel to the outlet channel with a mixing chamber defined within the mixing element, the mixing chamber having an inlet, an outlet opposite the inlet, and a tortuous path fluidly coupling the outlet to the port to intermix a first fluid flow and a second fluid received at the inlet of the mixing element into an intermixed fluid flow issued from the outlet of the mixing element.

20. The method as recited in claim 1, wherein the mixing element is a first mixing element with an insert portion defining a first mixing chamber, the method further comprising interchanging the first mixing element with a second mixing element, the second mixing element having an insert portion with a second mixing chamber.
